(19) United States
(12) Patent Application Publication
(10) Pub. No.: US 2006/0246906 A1
(43) Pub. Date: Nov. 2, 2006

(54) Method to handover dedicated and shared resources while in dual transfer mode

(75) Inventors: Rami Vaittinen, Singapore (SG); Iuliana Vaarinesee, Espoo (FI); Vlora Rexhepi, Espoo (FI); Guillaume Sebire, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/366,623

(22) Filed: Mar. 3, 2006

(30) Foreign Application Priority Data
Mar. 3, 2005 (EP) 05004745.5

(51) Int. Cl. H04Q 7/20

(52) U.S. Cl. 455/442; 455/438; 455/436

(57) ABSTRACT

A method for the handover of dedicated as well as shared resources for a communication device. The communication device simultaneously uses circuit switched and packet switched bearer services of a communication network according to a certain connection mode. The method comprises performing a handover procedure, wherein a change from old resources used by the communication device to new resources to be used by the communication device is effected simultaneously for dedicated as well as shared resources.

### FIELD OF THE INVENTION

The present invention relates to a method of handing over dedicated as well as shared resources in a dual transfer mode, i.e. the simultaneous participation of circuit switched and packet switched bearer services. The present invention also relates to a system, network element and communication device therefor.

### RELATED BACKGROUND ART

The first GSM (Global System for Mobile communication) networks were designed for voice services. When the use of the GSM data services started, it became evident that the Circuit Switched (CS) bearer services were not particularly well suited for certain types of applications with a nature including bursts. Therefore, the new Packet Switched (PS) data transmission service GPRS (General Packet Radio Service) was also defined for packet services. GPRS is a packet radio network utilizing the GSM network, which endeavors to optimize data packet transmission by means of GPRS protocol layers on the air interface between a mobile station MS and a GPRS network.

According to the standards documents 3GPP TS 23.060, “Service description; Stage 2”, a GPRS MS can operate in one of three modes of operation:

Class A mode of operation: The MS is attached to both GPRS and other GSM services. The mobile user can make and/or receive calls on the two services simultaneously e.g. having a normal GSM voice call and receiving GPRS data packets at the same time.

Class B mode of operation: The MS is attached to both GPRS and other GSM services, but the MS can only operate one set of services at a time.

Class C mode of operation: The MS can only be attached either to the GSM network or the GPRS network. The selection is done manually and there are no simultaneous operations.

The proposed application relates to the behavior of the MS that operates in class A mode of operation.

Based on the current standard 3GPP TS 44.018, “Radio resource Control Protocol”, an intercell or intracell change of channel(s) can be requested by the network radio resource (RR) sublayer, when the MS is in dual transfer mode (DTM). This change may be performed through the handover procedure. The MS shall abort its packet resources, if in class A mode of operation, and ask them again after the handover of (a) dedicated channel(s) has been performed successfully in the target cell. In document GP-032475, “PS Service Interruption Estimations for DTM Operation” it is estimated that the service outage time for PS resources due to internal handover would be about 820 ms. It shall be noted that a change of routing area and any packet recovery required in the cell change will add considerably to this estimation. For some conversational services this is not acceptable and therefore the service gap should be minimized.

FIG. 1 illustrates how the system is currently working. It shows the PS session being aborted in the source cell when the HANDOVER COMMAND message is received, while access is made in the CS domain and the RR signaling link is established. Further shown are the DTM procedures for requesting and assignment of resources and finally the re-establishment of the packet session including the cell update procedure.

### SUMMARY OF THE INVENTION

Therefore, it is an object of the present invention to overcome the problems stated above.

According to the present invention, this object is solved by handing over dedicated (CS) and shared (PS) resources at the same time in intercell or intracell cases. Embodiments of the present invention provide specific air-interface solutions to hand over.

Hence, it is an advantage of the present invention that the MS behavior which operates in class A mode can be enhanced.

According to one aspect of the present invention, there is provided a method of handing over dedicated as well as shared resources for a communication device which simultaneously uses circuit switched and packet switched bearer services of a communication network according to a certain connection mode, comprising: performing a handover procedure, wherein a change from old resources used by the communication device to new resources to be used by the communication device is effected simultaneously for dedicated as well as shared resources.

The connection mode of the communication device may be a dual transfer mode in which the communication device has the circuit switched bearer service and the packet switched bearer service, simultaneously.

According to a first embodiment, said step of performing a handover procedure further includes informing the communication device of the new dedicated and shared resources with a single message.

According to a second embodiment, said step of performing a handover procedure further includes informing the communication device of the new dedicated and shared resources by inserting respective parameters in one or more messages concerning the connectivity control of the communication device.

According to a third embodiment, said step of performing a handover procedure further includes informing the communication device of the new resources with a message pair comprising a message for the new dedicated resources and a message for the new shared resources.

A modification may be that a message for the new dedicated resources and a message for the new shared resources are identified by the communication device receiving them as said message pair informing of new resources if both include identifier linking both messages to each other.

Alternatively, a message for the new dedicated resources and a message for the new shared resources may be identified by the communication device receiving them as said message pair informing of new resources if the message for the new dedicated resources includes an identifier marking said message to that extent and the message for the new shared resources is received by the communication device within a predetermined time period before or after the receipt of the message for the new dedicated resources.

According to another aspect of the present invention, there is provided a system configured to handover dedicated as well as shared resources for a communication device which simultaneously uses circuit switched and packet switched bearer services of a communication network according to a certain connection mode, the system being further configured: to perform a handover procedure, wherein elements of the system are operably connected to simultaneously effect a change from old resources used by the communication device to new resources to be used by the communication device for dedicated as well as shared resources.

The connection mode of the communication device may be configured to be a dual transfer mode in which the communication device has the circuit switched bearer service and the packet switched bearer service, simultaneously.

According to the first embodiment, said configuration to perform a handover procedure further includes an operable connection to the communication device allowing to inform of the new dedicated and shared resources with a single message.

According to the second embodiment, said configuration to perform a handover procedure further includes an operable connection to the communication device allowing to inform of the new dedicated and shared resources by respective parameters inserted in one or more messages concerning the connectivity control of the communication device.

According to the third embodiment, said configuration to perform a handover procedure further includes an operable connection to the communication device allowing to inform of the new resources with a message pair comprising a message for the new dedicated resources and a message for the new shared resources.

A modification may be that the communication device is configured to identify a message for the new dedicated resources and a message for the new shared resources as said message pair informing of new resources by detecting identifier included therein linking both messages to each other.

Alternatively, the communication device may be configured to identify a message for the new dedicated resources and a message for the new shared resources as said message pair informing of new resources by detecting an identifier in the message for the new dedicated resources marking said message to that extent and detecting the receipt of the message for the new shared resources within a predetermined time period before or after the receipt of the message for the new dedicated resources.

According to still another aspect of the present invention, there is provided a network element configured to handover dedicated as well as shared resources for a communication device which simultaneously uses circuit switched and packet switched bearer services of a communication network according to a certain connection mode, the network element being further configured: to perform a handover procedure by being operably connected with the communication device so as to simultaneously effect a change from old resources used by the communication device to new resources to be used by the communication device for dedicated as well as shared resources.

The network element may be further configured to provide the communication device with a dual transfer mode of establishing and/or receiving calls in or across the communication network on the circuit switched bearer service and the packet switched bearer service, simultaneously, as the connection mode.

According to the first embodiment, the network element is further configured to inform the communication device of the new dedicated and shared resources with a single message.

According to the second embodiment, the network element is further configured to inform the communication device of the new dedicated and shared resources by respective parameters inserted in one or more messages concerning the connectivity control of the communication device.

According to the third embodiment, the network element is further configured to inform the communication device of the new resources with a message pair comprising a message for the new dedicated resources and a message for the new shared resources.

A modification may be that the configuration includes to insert identifier into both a message for the new dedicated resources and a message for the new shared resources so as to identify them as said message pair informing of new resources and to link both messages to each other.

Alternatively, the configuration may include to insert an identifier in the message for the new dedicated resources marking said message to belong to said message pair informing of new resources.

According to still another aspect of the present invention, there is provided a communication device configured to simultaneously use circuit switched and packet switched bearer services of a communication network according to a certain connection mode, the communication device being further configured: to perform a handover procedure by simultaneously effecting a change from old resources used by the communication device to new resources to be used by the communication device for dedicated as well as shared resources.

The connection mode of the communication device may be configured to be a dual transfer mode of establishing and/or receiving calls in or across the communication network on the circuit switched bearer service and the packet switched bearer service, simultaneously.

According to the first embodiment, said configuration to perform a handover procedure further includes to be informed of the new dedicated and shared resources with a single message.

According to the second embodiment, said configuration to perform a handover procedure further includes to be informed of the new dedicated and shared resources by respective parameters inserted in one or more messages concerning the connectivity control of the communication device.

According to the third embodiment, said configuration to perform a handover procedure further includes to be informed of the new resources with a message pair comprising a message for the new dedicated resources and a message for the new shared resources.

A modification may be that the communication device is configured to identify a message for the new dedicated resources and a message for the new shared resources as said message pair informing of new resources by detecting identifier included therein linking both messages to each other.

Alternatively, the communication device may be configured to identify a message for the new dedicated resources and a message for the new shared resources as said message pair informing of new resources by detecting an identifier in the message for the new dedicated resources marking said message to that extent and detecting the receipt of the message for the new shared resources within a predetermined time period before or after the receipt of the message for the new dedicated resources.

### BRIEF DESCRIPTION OF THE DRAWINGS

Further features, modifications and advantages will be apparent from the following description of the preferred embodiments of the present invention which is to be taken in conjunction with the accompanying drawings, in which:

FIG. 1 shows an intercell handover procedure of a mobile station in dual transfer mode according to the prior art; and

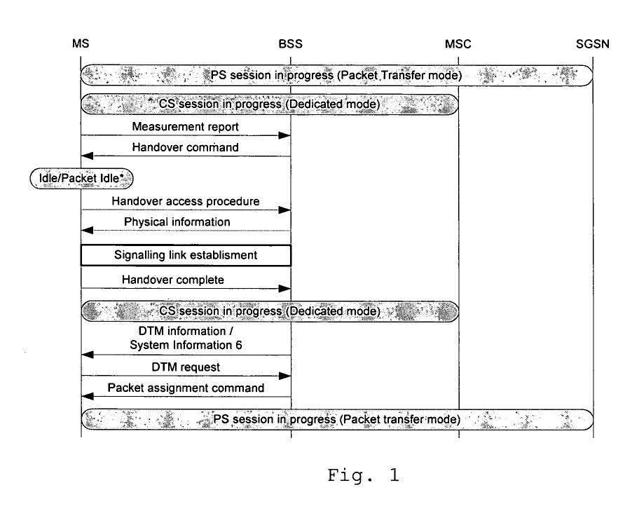

FIG. 2 shows a handover procedure of dedicated and shared resources for a mobile station in dual transfer mode according to the present invention.

### DESCRIPTION OF THE PREFERRED EMBODIMENTS

In the following, details of the present invention are described by referring to what is presently considered as preferred embodiments thereof without limiting the invention thereto.

First embodiment: Use of a new DTM HANDOVER COMMAND message

While being in dual transfer mode, the MS regularly sends either MEASUREMENT REPORT or ENHANCED MEASUREMENT REPORT messages to the network, that is to the source base station subsystem BSS. These messages contain measurement results about reception characteristics from the current cell and from neighboring cells. Upon reception of measurement messages the network may originate an intracell or intercell handover of dedicated and shared resources by sending e.g. HANDOVER REQUIRED (for CS) and PS HANDOVER REQUIRED (for PS) messages. Another approach would be to enhance the HANDOVER REQUIRED (for CS) message by including an indication that both resources need to be handed over.

After the signaling between the source and target base station subsystems and the core network elements (mobile services switching center MSC and serving GPRS support node SGSN) and if both dedicated and shared resources have been successfully allocated in the target BSS, the HANDOVER COMMAND and PS HANDOVER COMMAND messages are sent by MSC and SGSN to the source BSS, for example. Another way would be to enhance the HANDOVER COMMAND message by including an indication that both resources can be handed over to the target BSS.

Upon the receipt of indication(s) from the core network that PS and CS handover can occur, the source BSS sends, for example, a new DTM HANDOVER COMMAND message to the MS on the air interface. This message is meant to contain all information the MS needs for performing the PS and CS handover to the target cell.

According to the present embodiment, there are several approaches to construct this message:

1) It is a preferred approach to define this message as a layer 3 signaling message (RR protocol layer in GSM/GPRS standard), and to encapsulate this message in a layer 2 signaling message (RLC/MAC protocol layer in GSM/GPRS standard), into e.g. the existing PACKET CS COMMAND message or into a new message, and to send it on the packet associated control channel (PACCH).

Sending an RR message in DTM means to use the main dedicated control channel (DCCH) (here, the fast associated control channel (FACCH)), using LAPDm layer 2 protocol (link access protocol on the Dm channel). Because the LAPDm window size is 1, and given this message may be particularly large due to the amount of information it contains (CS and PS information), using LAPDm could be too time consuming especially when considering that a handover is performed.

In this case, because in DTM the RLC/MAC protocol (radio link control/media access control) is also active, it is possible to benefit from an extended RLC/MAC control message segmentation, and to avoid an unnecessary delay of the DTM handover. The encapsulation of a RR message within a RLC/MAC control message is defined in document 3GPP TS 44.060, “Radio Link Control/Medium Access Control (RLC/MAC) protocol”. 2) Another approach is to define this message as a layer 2 RLC/MAC control message without using encapsulation.

The preferred approach described above however avoids the problem that the initiation of the DTM handover procedure is done by the RR protocol when initiating CS Handover. Therefore, the complex process of defining the interaction between RR and RLC/MAC protocols, since a procedure would be defined in RR protocol, while the corresponding signaling would be defined in RLC/MAC protocol, is avoided according to the above described preferred approach.

3) A third approach is to define this message as a layer 2 RLC/MAC control message which would encapsulate the RR message for CS handover (HANDOVER COMMAND message), and which contains RLC/MAC specific information for the PS handover. This could limit the amount of interaction needed by keeping the information of a given layer defined by that layer.

With each alternative, some interworking between different protocol layers is needed, yet, still, the RR layer is the protocol triggering the DTM handover procedure based e.g. on the measurements done on that layer. However, it is remarked that some interworking between the layers has already been introduced with the existing PACKET CS COMMAND message.

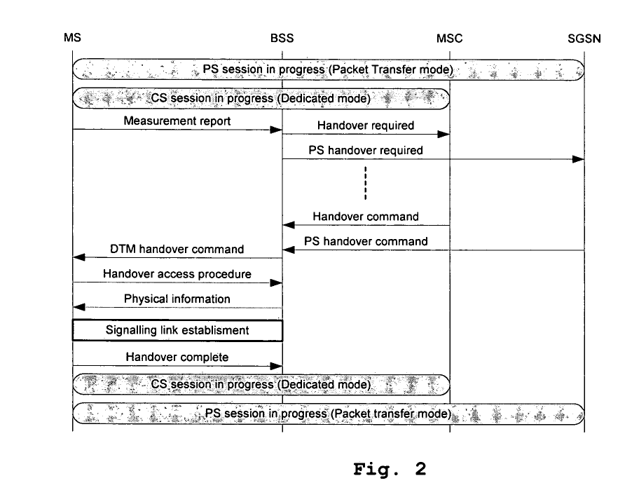

FIG. 2 shows the signaling diagram of dedicated and shared resources with the new DTM HANDOVER COMMAND message.

The structure of the new DTM HANDOVER COMMAND message according to the present embodiment is presented in the following. In addition, information elements listed in the DTM HANDOVER COMMAND message RAC, MAX_LAPDm and GPRS_MS_TXPWR_MAX_CCH parameters shall be included in the message.

| | Information | Type/ | Pres- | | |
|---|---|---|---|---|---|
| IEI | element | Reference | ence | Format | length |
| | RR management | Protocol | M | V | ½ |
| | Protocol | Discriminator | | | |
| | Discriminator | 10.2 | | | |
| | Skip Indicator | Skip Indicator | M | V | ½ |
| | | 10.3.1 | | | |
| | DTM Handover | Message Type | M | V | 1 |
| | Command Message | 10.4 | | | |
| | Type | | | | |
| | Cell | Cell | M | V | 2 |
| | Description | description | | | |
| | | 10.5.2.2 | | | |
| | Description of | Channel | M | V | 3 |
| | the first | Description 2 | | | |
| | channel, after | 10.5.2.5a | | | |
| | time | | | | |
| | Handover | Handover | M | V | 1 |
| | Reference | Reference | | | |
| | | 10.5.2.15 | | | |
| | Power Command | Power Command | M | V | 1 |
| | and Access type | and Access type | | | |
| | | 10.5.2.28a | | | |
| D- | Synchronization | Synchronization | O | TV | 1 |
| | Indication | Indication | | | |
| | | 10.5.2.39 | | | |
| 02 | Frequency Short | Frequency Short | C | TV | 10 |
| | List, after | List | | | |
| | time | 10.5.2.14 | | | |
| 05 | Frequency List, | Frequency List | C | TLV | 4-131 |
| | after time | 10.5.2.13 | | | |
| 62 | Cell Channel | Cell Channel | C | TV | 17 |
| | Description | Description | | | |
| | | 10.5.2.1b | | | |
| 10 | Description of | Multislot | C | TLV | 3-12 |
| | the multislot | Allocation | | | |
| | configuration | 10.5.2.21b | | | |
| 63 | Mode of the | Channel Mode | O | TV | 2 |
| | First | 10.5.2.6 | | | |
| | Channel (Channel | | | | |
| | Set 1)) | | | | |
| 11 | Mode of Channel | Channel Mode | O | TV | 2 |
| | Set 2 | 10.5.2.6 | | | |
| 13 | Mode of Channel | Channel Mode | O | TV | 2 |
| | Set 3 | 10.5.2.6 | | | |
| 14 | Mode of Channel | Channel Mode | O | TV | 2 |
| | Set 4 | 10.5.2.6 | | | |
| 15 | Mode of Channel | Channel Mode | O | TV | 2 |
| | Set 5 | 10.5.2.6 | | | |
| 16 | Mode of Channel | Channel Mode | O | TV | 2 |
| | Set 6 | 10.5.2.6 | | | |
| 17 | Mode of Channel | Channel Mode | O | TV | 2 |
| | Set 7 | 10.5.2.6 | | | |
| 18 | Mode of Channel | Channel Mode | O | TV | 2 |
| | Set 8 | 10.5.2.6 | | | |
| 64 | Description of | Channel | O | TV | 4 |
| | the Second | Description | | | |
| | Channel, after | 10.5.2.5 | | | |
| | time | | | | |
| 66 | Mode of the | Channel Mode 2 | O | TV | 2 |
| | Second Channel | 10.5.2.7 | | | |
| 69 | Frequency | Frequency | C | TV | 10 |
| | Channel | Channel | | | |
| | Sequence, after | Sequence | | | |
| | time | 10.5.2.12 | | | |
| 72 | Mobile | Mobile | C | TLV | 3-10 |
| | Allocation, | Allocation | | | |
| | after time | 10.5.2.21 | | | |
| 7C | Starting Time | Starting Time | O | TV | 3 |
| | | 10.5.2.38 | | | |
| 7B | Real Time | Time Difference | C | TLV | 3 |
| | Difference | 10.5.2.41 | | | |
| 7D | Timing Advance | Timing Advance | C | TV | 2 |
| | | 10.5.2.40 | | | |
| 12 | Frequency Short | Frequency Short | C | TV | 10 |
| | List, before | List | | | |
| | time | 10.5.2.14 | | | |
| 19 | Frequency List, | Frequency List | C | TLV | 4-131 |
| | before time | 10.5.2.13 | | | |
| 1C | Description of | Channel | O | TV | 4 |
| | the First | Description 2 | | | |
| | Channel, before | 10.5.2.5a | | | |
| | time | | | | |
| 1D | Description of | Channel | O | TV | 4 |
| | the Second | Description | | | |
| | Channel, before | 10.5.2.5 | | | |
| | time | | | | |
| 1E | Frequency | Frequency | C | TV | 10 |
| | channel | channel | | | |
| | sequence before | sequence | | | |
| | time | 10.5.2.12 | | | |
| 21 | Mobile | Mobile | C | TLV | 3-10 |
| | Allocation, | Allocation | | | |
| | before time | 10.5.2.21 | | | |
| 9- | Cipher Mode | Cipher Mode | O | TV | 1 |
| | Setting | Setting | | | |
| | | 10.5.2.9 | | | |
| 01 | VGCS target | VGCS target | O | TLV | 3 |
| | mode Indication | mode Indication | | | |
| | | 10.5.2.42a | | | |
| 03 | Multi-Rate | MultiRate | O | TLV | 4-8 |
| | configuration | configuration | | | |
| | | 10.5.2.21aa | | | |
| 76 | Dynamic ARFCN | Dynamic ARFCN | O | TLV | 6-34 |
| | Mapping | Mapping | | | |
| | | 10.5.2.11b | | | |
| | GPRS broadcast | GPRS broadcast | M | LV | 7-n |
| | information | information | | | |
| | | 10.5.2.14d | | | |
| 15 | Description of | RR Packet | O | TLV | 3-n |
| | the Uplink | Uplink | | | |
| | Packet Channel | Assignment | | | |
| | Assignment | 10.5.2.25c | | | |
| 16 | Description of | RR Packet | O | TLV | 3-n |
| | the Downlink | Downlink | | | |
| | Packet Channel | Assignment | | | |
| | Assignment | 10.5.2.25d | | | |

Second Embodiment: Use of existing HANDOVER COMMAND or DTM ASSIGNMENT COMMAND messages with new parameters

According to a second preferred embodiment of the present invention the existing messages specified in document 3GPP TS 44.018, “Radio Resource Control Protocol” and in document 3GPP TS 44.060, “Radio Link Control/Medium Access Control (RLC/MAC) protocol” are utilized by adding necessary missing parameters to make a DTM handover possible. The messages sent on the RR layer on the main DCCH can be enhanced so that for example, with the HANDOVER COMMAND message, similar parameters as those described above in connection with the presentation of the first embodiment are added, and with the DTM ASSIGMENT COMMAND message at least frequency parameters need to be added. On the RLC/MAC layer level the messages PACKET TIMESLOT RECONFIGURE or MULTIPLE TBF TIMESLOT RECONFIGURE (temporary block flow) can be utilized, for example, with added dedicated resource parameters.

In case of the RR control messages, like the HANDOVER COMMAND or the DTM ASSIGNMENT COMMAND message sent on the main DCCH, the problem of the window size of the LAPDm protocol exists as discussed above in connection with the first embodiment.

Apart from that, the benefits of enhanced current RLC/MAC level messages are similar to those explained above in connection with the first the first embodiment with respect to a new RLC/MAC level control message.

Third embodiment: Use of HANDOVER COMMAND and PS HANDOVER COMMAND messages

According to the third embodiment of the present invention both the HANDOVER COMMAND and the PS HANDOVER COMMAND messages are used to make DTM handover, in which case it is preferable—so as to avoid introducing unnecessary delays—not to send these messages consecutively (i.e. not to define that the BSS would e.g. send the PS HANDOVER COMMAND message only if the HANDOVER COMMAND message has been received).

In the existing HANDOVER COMMAND message a new parameter indicating that the message is sent as part of the DTM handover procedure needs to be added. A similar indication can be necessary in the PS HANDOVER COMMAND message, wherein it is to be noted that it is stated in document 3GPP TS 43.129, “Packet-switched handover for GERAN A/Gb mode; Stage 2” that the existing Packet Cell Change Order (PCCO) message enhanced with the PS Handover related information element (IE) is a suitable message to be used as PS handover Command. Such indication (hereinafter referred to as “PSCS HO Indication”) could be a single bit, or to provide a more robust mechanism (i.e. to offer a unique link between the HANDOVER COMMAND message and the PS HANDOVER COMMAND message), a bitstring (random or not) which could be included in both messages to allow the MS to perform some integrity check between the two messages.

It is to be noted that the sole reception of a PS HANDOVER COMMAND message in DTM could as well be defined so that it is to be understood as a DTM handover i.e. that it is to be linked with a HANDOVER COMMAND message. In that case, the “PSCS HO Indication” could be included in the HANDOVER COMMAND message alone in order to distinguish it from a traditional CS HANDOVER in DTM. This would not provide a unique link between the two messages, but can be sufficient.

Sending two separate messages (potentially linked by a “PSCS HO Indication”) for performing a combined procedure requires a synchronization between RR and RLC/MAC. One or two timers can be used on MS side for this purpose:

Case 1: “PSCS HO Indication” in both messages:

Timer T1 is started upon receipt of the HANDOVER COMMAND message including a “PSCS HO Indication”, provided that timer T2 is not running. Timer T1 is stopped upon receipt of the PS HANDOVER COMMAND message including the same “PSCS HO Indication”. Upon expiry of the timer T1, the MS shall proceed with the CS handover as indicated in the HANDOVER COMMAND message.

Timer T2 is started upon receipt of the PS HANDOVER COMMAND message including a “PSCS HO Indication”, provided that timer T1 is not running. Timer T2 is stopped upon receipt of the HANDOVER COMMAND message including the same “PSCS HO Indication”. Upon expiry of timer T2, the MS shall discard the PS HANDOVER COMMAND message. Alternatively, it could be considered also to obey the PS HANDOVER COMMAND message upon expiry of timer T2.

Case 2: “PSCS HO Indication” in HANDOVER COMMAND message alone:

Timer T1 is started upon receipt of the HANDOVER COMMAND message including a “PSCS HO Indication”, provided that timer T2 is not running. Timer T1 is stopped upon receipt of the PS HANDOVER COMMAND message. Upon expiry of timer T1 , the MS shall proceed with the CS handover as indicated in the HANDOVER COMMAND message.

Timer T2 is started upon receipt of the PS HANDOVER COMMAND message, provided that timer T1 is not running. Timer T2 is stopped upon receipt of the HANDOVER COMMAND message including a “PSCS HO Indication”. Upon expiry of timer T2, the MS shall discard the PS HANDOVER COMMAND message. Alternatively, it could be considered also to obey the PS HANDOVER COMMAND message upon expiry of timer T2.

It is to be noted that the same can be achieved using a single timer and distinguishing the cases described above (the timer guards the reception of the missing handover message. Upon expiry, the MS proceeds with the handover command it has received (or possibly discards it if it were a PS HO COMMAND message)).

Another option (instead of timers) is to use the starting time parameter transmitted in the HANDOVER COMMAND message or IMMEDIATE_REL parameter transmitted in the PACKET CELL CHANGE ORDER (likely PS handover message in air-interface) message. The network assigns the starting time in the message transmitted first over air-interface (either HANDOVER COMMAND or PS HANDOVER COMMAND message), and the MS awaits the receipt of another handover message, while the given starting time is running until it is moved to the allocated resources in the target cell. At the expiry of the starting time and if the MS has not received another handover message, it acts upon the information given in the first handover message.

It is to be noted that the present embodiment needs additional synchronisation requirements at the MS side to make a successful DTM handover.

The present embodiment has the advantage to keep the possibility for ciphering the HANDOVER COMMAND.

All embodiments: The reply of the mobile station on the receipt of the DTM HANDOVER COMMAND or another message

After lower layer connections are successfully established, the mobile station returns the existing HANDOVER COMPLETE message, specifying cause “normal event” to the network on the main DCCH.

The sending of this message on the mobile station side and its receipt on the network side allow the resumption of the transmission of signaling layer messages other than those for RR management.

The DTM handover procedure has successfully completed when the MS has entered dual transfer mode.

According to the present invention, the MS can maintain PS resources and gain a better quality of service for a packet application.

The present invention is considered to be applicable with further advantages for the so-called GERAN system (GSM enhanced data in GSM radio access network—GSM EDGE RAN).

While it has been described above what is presently considered to be preferred embodiments of the present invention it is to be understood by those who are skilled in the art that various modifications thereof may be made without deviating from the spirit and scope of the present invention as defined by the appended claims.

Thus, what is described above is a method of handing over dedicated as well as shared resources for a communication device which simultaneously uses circuit switched and packet switched bearer services of a communication network according to a certain connection mode, comprising: performing a handover procedure, wherein a change from old resources used by the communication device to new resources to be used by the communication device is effected simultaneously for dedicated as well as shared resources.

1. A method of handing over dedicated resources and shared resources for a communication device which simultaneously uses circuit switched bearer services and packet switched bearer services of a communication network according to a certain connection mode, comprising:
performing a handover procedure, wherein a change from old resources used by the communication device to new resources to be used by the communication device is effected simultaneously for dedicated resources and shared resources.

2. The method according to claim 1, wherein the connection mode of the communication device is in a dual transfer mode in which the communication device has the circuit switched bearer service and the packet switched bearer service, simultaneously.

3. The method according to claim 1, wherein said step of performing a handover procedure further includes informing the communication device of new dedicated resources and new shared resources with a single message.

4. The method according to claim 1, wherein said step of performing a handover procedure further includes informing the communication device of new dedicated resources and new shared resources by inserting respective parameters in one or more messages concerning the connectivity control of the communication device.

5. The method according to claim 1, wherein said step of performing a handover procedure further includes informing the communication device of the new resources with a message pair comprising a message for new dedicated resources and a message for new shared resources.

6. The method according to claim 5, wherein the message for the new dedicated resources and the message for the new shared resources are identified by the communication device receiving them as said message pair, said message pair being used for informing of new resources if both the message for the new dedicated resources and the message for the new shared resources include an identifier linking both messages to each other.

7. The method according to claim 5, wherein the message for the new dedicated resources and the message for the new shared resources are identified by the communication device receiving them as said message pair, said message pair being used for informing of new resources if the message for the new dedicated resources includes an identifier marking said message for the new dedicated resources to that extent and the message for the new shared resources is received by the communication device within a predetermined time period before or after the receipt of the message for the new dedicated resources.

8. A system configured to handover dedicated resources and shared resources for a communication device which simultaneously uses circuit switched bearer services and packet switched bearer services of a communication network according to a certain connection mode, the system being further configured:
to perform a handover procedure, wherein elements of the system are operably connected to simultaneously effect a change from old resources used by the communication device to new resources to be used by the communication device for dedicated resources and shared resources.

9. The system according to claim 8, wherein the connection mode of the communication device is configured to be a dual transfer mode in which the communication device has the circuit switched bearer service and the packet switched bearer service, simultaneously.

10. The system according to claim 8, wherein said configuration to perform a handover procedure further includes an operable connection to the communication device for informing of new dedicated resources and new shared resources with a single message.

11. The system according to claim 8, wherein said configuration to perform a handover procedure further includes an operable connection to the communication device for informing of new dedicated resources and new shared resources by respective parameters inserted in one or more messages concerning the connectivity control of the communication device.

12. The system according to claim 8, wherein said configuration to perform a handover procedure further includes an operable connection to the communication device for informing of the new resources with a message pair comprising a message for new dedicated resources and a message for new shared resources.

13. The system according to claim 12, wherein the communication device is configured to identify the message for the new dedicated resources and the message for the new shared resources as said message pair informing of new resources by detecting an identifier included therein linking both messages to each other.

14. The system according to claim 12, wherein the communication device is configured to identify the message for the new dedicated resources and the message for the new shared resources as said message pair, the message pair being used to for informing of new resources by detecting an identifier in the message for the new dedicated resources, marking said message for the new dedicated resources to that extent and detecting the receipt of the message for the new shared resources within a predetermined time period before or after the receipt of the message for the new dedicated resources.

15. A network element configured to handover dedicated resources and shared resources for a communication device which simultaneously uses circuit switched bearer services and packet switched bearer services of a communication network according to a certain connection mode, the network element being further configured:
to perform a handover procedure by being operably connected with the communication device so as to simultaneously effect a change from old resources used by the communication device to new resources to be used by the communication device for dedicated resources and shared resources.

16. The network element according to claim 15, further configured to provide the communication device with a dual transfer mode in which the communication device has the circuit switched bearer service and the packet switched bearer service, simultaneously, as the connection mode.

17. The network element according to claim 15, further configured to inform the communication device of new dedicated resources and new shared resources with a single message.

18. The network element according to claim 15, further configured to inform the communication device of new dedicated resources and new shared resources by respective parameters inserted in one or more messages concerning the connectivity control of the communication device.

19. The network element according to claim 15, further configured to inform the communication device of the new resources with a message pair comprising a message for the new dedicated resources and a message for the new shared resources.

20. The network element according to claim 19, wherein the configuration includes means for inserting an identifier into both the message for the new dedicated resources and the message for the new shared resources so as to identify them as said message pair, said message pair being used to inform of new resources and to link both messages to each other.

21. The network element according to claim 12, wherein the configuration includes means for inserting an identifier in the message for the new dedicated resources and marking said message for the new dedicated resources to belong to said message pair informing of new resources.

22. A communication device configured to simultaneously use circuit switched bearer services and packet switched bearer services of a communication network according to a certain connection mode, the communication device being further configured:
to perform a handover procedure by simultaneously effecting a change from old resources used by the communication device to new resources to be used by the communication device for dedicated resources and shared resources.

23. The communication device according to claim 22, wherein the connection mode of the communication device is configured to be a dual transfer mode in which the communication device has the circuit switched bearer service and the packet switched bearer service, simultaneously.

24. The communication device according to claim 22, wherein said configuration to perform a handover procedure further includes means for informing of new dedicated resources and new shared resources with a single message.

25. The communication device according to claim 22, wherein said configuration to perform a handover procedure further includes means for informing of new dedicated resources and new shared resources by respective parameters inserted in one or more messages concerning the connectivity control of the communication device.

26. The communication device according to claim 22, wherein said configuration to perform a handover procedure further includes means for informing of the new resources with a message pair comprising a message for the new dedicated resources and a message for the new shared resources.

27. The communication device according to claim 26, wherein the communication device is configured to identify the message for the new dedicated resources and the message for the new shared resources as said message pair, said message pair being used for informing of new resources by detecting an identifier included therein linking both messages to each other.

28. The communication device according to claim 26, wherein the communication device is configured to identify the message for the new dedicated resources and the message for the new shared resources as said message pair, said message pair being used for informing of new resources by detecting an identifier in the message for the new dedicated resources, marking said message for the new dedicated resources to that extent and detecting the receipt of the message for the new shared resources within a predetermined time period before or after the receipt of the message for the new dedicated resources.

29. A computer program embodied on a computer readable medium, the computer program being used to implement a method of handing over dedicated resources and shared resources for a communication device which simultaneously uses circuit switched bearer services and packet switched bearer services of a communication network according to a certain connection mode, the method comprising:
performing a handover procedure, wherein a change from old resources used by the communication device to new resources to be used by the communication device is effected simultaneously for dedicated resources and shared resources.
